(19) United States
(12) Patent Application Publication
(10) Pub. No.: US 2026/0289939 A1
(43) Pub. Date: Sep. 24, 2026

(54) IMAGE PROCESSING USING HIGH RESOLUTION IMAGES

(71) Applicant: Synaptics Incorporated, San Jose, CA (US)

(72) Inventors: Zacchaeus Scheffer, San Jose, CA (US); Karthikeyan Shanmuga Vadivel, San Jose, CA (US); Brendan Reidy, San Jose, CA (US)

(73) Assignee: Synaptics Incorporated, San Jose, CA (US)

(21) Appl. No.: 19/088,720

(22) Filed: Mar. 24, 2025

(51) Int. Cl. G06V 10/25; G06T 3/4015; G06V 10/24; G06V 10/32; G06V 40/16

(52) U.S. Cl. CPC G06V 10/25; G06T 3/4015; G06V 10/242; G06V 10/32; G06V 40/165

(57) ABSTRACT

This disclosure provides methods, devices, and systems for image processing. The present implementations more specifically relate to object identification using high resolution images. In some implementations, an image analysis system may obtain a source image; detect one or more objects of interest in the source image; obtain a first portion of the source image based on the one or more detected objects of interest and a buffer size associated with detecting the one or more objects of interest in the source image; demosaic the first portion of the source image; and perform one or more image processing operations based on the demosaiced first portion of the source image.

### TECHNICAL FIELD

The present implementations relate generally to image processing, and specifically to image processing using high resolution images.

### BACKGROUND OF RELATED ART

Computer vision is a field of artificial intelligence (AI) that mimics the human visual system to draw inferences about an environment from images or video of the environment. Example computer vision technologies include object detection, object classification, and object identification, among other examples. Object detection encompasses various techniques for detecting objects in the environment that belong to a known class (such as humans, vehicles, or animals). Object identification encompasses various techniques for determining the identity of an object detected in the environment (e.g., detecting a face and identifying the person corresponding to the detected face).

Higher resolution images, such as high-definition images, offer the potential for increased accuracy in inferences made using computer vision technologies. For example, higher resolution images can provide more detailed information. However, higher resolution images require more memory and processing resources for inferencing than lower resolution images. Accordingly, systems and devices that are equipped with limited resources, such as systems and devices with limited memory, may not have sufficient resources to implement computer vision technologies with higher resolution image inputs.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter of this disclosure can be implemented in a method of processing images. The method includes obtaining a source image; detecting one or more objects of interest in the source image; obtaining a first portion of the source image based on the one or more detected objects of interest and a buffer size associated with detecting the one or more objects of interest in the source image; demosaicing the first portion of the source image; and performing one or more image processing operations based on the demosaiced first portion of the source image.

Another innovative aspect of the subject matter of this disclosure can be implemented in an image analysis system, which includes one or more processors and a memory coupled to the one or more processors. The memory stores instructions that, when executed by the one or more processors, cause the image analysis system to obtain a source image; detect one or more objects of interest in the source image; obtain a first portion of the source image based on the one or more detected objects of interest and a buffer size associated with detecting the one or more objects of interest in the source image; demosaic the first portion of the source image; and perform one or more image processing operations based on the demosaiced first portion of the source image.

### BRIEF DESCRIPTION OF THE DRAWINGS

The present implementations are illustrated by way of example and are not intended to be limited by the figures of the accompanying drawings.

FIGS. 1A-1B show block diagrams of an example image analysis system, according to some implementations.

FIG. 2 shows an example memory space for an image analysis system, according to some implementations.

FIG. 3 shows a block diagram of an example image analysis component, according to some implementations.

FIG. 4 shows another block diagram of an example image analysis system, according to some implementations.

FIG. 5 shows an illustrative flowchart depicting an example operation for image processing, according to some implementations.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. The terms “electronic system” and “electronic device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example input devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random-access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors (or a processing system). The term “processor,” as used herein may refer to any general-purpose processor, special-purpose processor, conventional processor, controller, microcontroller, and/or state machine capable of executing scripts or instructions of one or more software programs stored in memory.

As described above, computer vision techniques may include object identification. An example of object identification is facial recognition. Facial recognition techniques may include detecting a face of a person in an image and comparing the detected face to a database of known faces, in order to identify the person to which the detected face belongs. Aspects of the present disclosure recognize that higher resolution images generally include more details and/or features that can be used to produce more accurate facial recognition results (compared to lower resolution images).

In many image capture devices (e.g., camera), a color filter array is placed over the array of imaging sensors in the image capture device. Based on the color filter array, the image capture device captures a source image, which includes for each pixel information for a single color based on the corresponding pixel position in the color filter array. The source image may be demosaiced to generate a full-color image, which includes for each pixel information for multiple colors. Aspects of the present disclosure recognize that a source image occupies less memory than a full-color image generated by demosaicing the source image.

A facial recognition process may include various processing steps that can be performed on the image itself or on an output from a prior processing step. Many computing devices may have a predetermined memory allocation for computer vision processes, such as facial recognition. Within that predetermined memory allocation, respective portions may be reserved for specific processing steps. Many facial recognition processes use demosaiced images as inputs. However, the memory allocation, or even the total amount of memory, at a device may be insufficient for accepting a demosaiced image as input into a facial recognition process. For example, as image capture devices capable of capturing higher resolution images proliferate, devices implementing facial recognition processes may be unable to use higher resolution demosaiced images as inputs due to insufficient memory to store or process those images, as compared to lower resolution demosaiced images. Aspects of the present disclosure recognize that using a non-demosaiced image as input in a facial recognition process, and demosaicing certain portions of the non-demosaiced image during the process, may help reduce memory expense compared to using demosaiced images as input into the process and processing the demosaiced image throughout.

Various aspects of this disclosure relate generally to computer vision, and more particularly, to image processing using high definition images. In some aspects, an image analysis system may be configured to obtain a source image; detect one or more objects of interest in the source image; obtain a first portion of the source image based on the one or more detected objects of interest and a buffer size associated with detecting the one or more objects of interest in the source image; demosaic the first portion of the source image; and perform the one or more image processing operations based on the demosaiced first portion of the source image.

Particular implementations of the subject matter described in this disclosure can be implemented to realize one or more of the following potential advantages. By using a non-demosaiced source image as input images into an image processing pipeline, demosaicing a portion of the source image corresponding to an ROI determined by an object detection operation of the pipeline, and storing the demosaiced portion in an input buffer associated with the object detection operation, a facial recognition process can benefit from the additional information input obtained via increasing the resolution of the input images (e.g., more detail, more features), while staying within the memory budget of a memory allocation associated with the implementing device or system. Accordingly, aspects of the present disclosure can improve the accuracy of facial recognition on devices and systems with limited memory budgets.

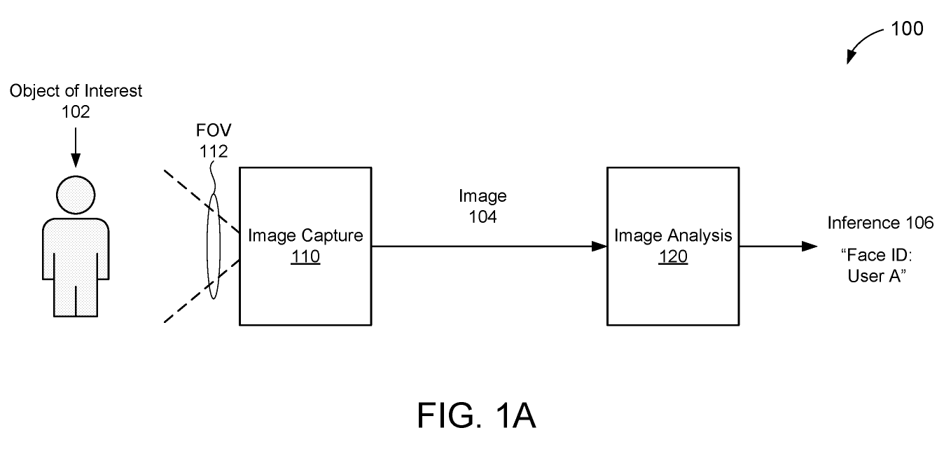

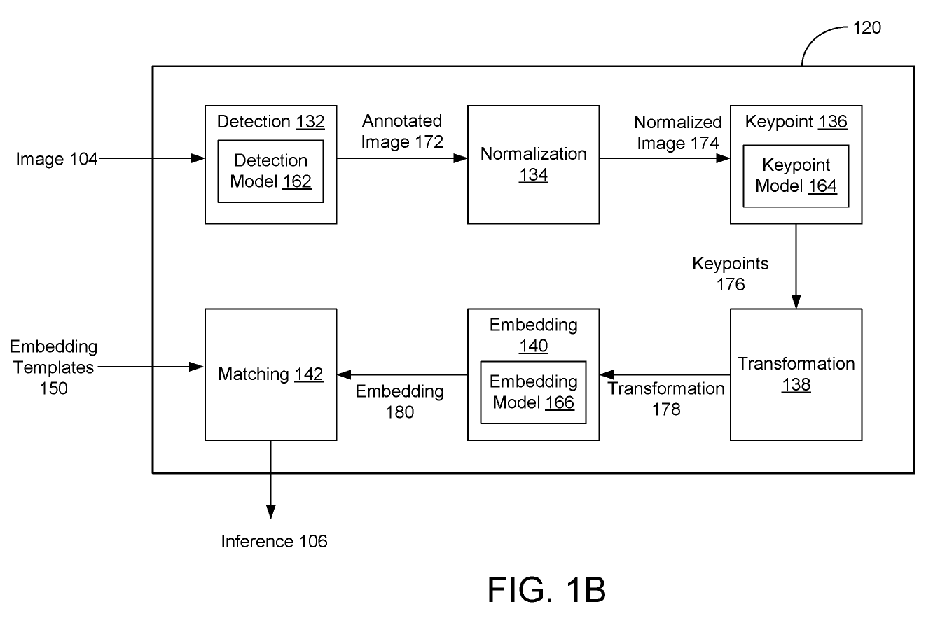

FIGS. 1A-1B show block diagrams of an example image analysis system 100, according to some implementations. In particular, FIG. 1A illustrates the image analysis system 100, and FIG. 1B illustrates an image analysis component 120 of the image analysis system 100 in further detail. In some aspects, the image analysis system 100 may be configured to detect one or more objects of interest and generate one or more inferences 106 about the objects of interest (e.g., recognizing a face and identifying a person corresponding to the face). In some implementations, an inference 106 may include an identifier associated with a known face (such as a name or other identifier corresponding to the person to which the face belongs). In some implementations, the inference 106 may be an indication that the object of interest is “unknown” or otherwise not identifiable (e.g., if the image analysis system 100 failed to identify the object of interest).

The system 100 includes an image capture component 110 and an image analysis component 120.

The image capture component 110 may be any imaging sensor or device (such as a camera) configured to capture a pattern of light in its field-of-view (FOV) 112 and convert the pattern of light to a digital image (e.g., image 104). In some implementations, the image capture component 110 includes an array of imaging sensors. For example, a digital image 104 may include an array of pixels (or pixel values) representing the pattern of light in the FOV 112 of the image capture component 110. In some implementations, the image capture component 110 may continuously (or periodically) capture a series of images representing a digital video. In the example of FIG. 1A, an object of interest 102 located within the FOV 112 is depicted as a person. As a result, the image 104 may include the object of interest 102.

In some aspects, the image capture component 110 captures images using a color filter array. For example, the image capture component 110 captures the pattern of light in the FOV 112, filtered by a color filter array overlaid on the array of imaging sensors, and convert that filtered pattern of light to a digital image that includes the array of pixels, where each pixel includes information for a single color amongst the colors associated with the color filter array. An example of a color filter array is a Bayer color filter. As used herein, the term “source image” refers to a digital image that includes per-pixel single-color information (e.g., an intensity value for a single color) based on a color filter array. A source image may be demosaiced into a full-color (e.g., RGB) image, where each pixel in the array of pixels includes information for multiple colors (e.g., a pixel in an RGB image includes respective intensity values for red, green, and blue).

Thus, demosaicing a source image may include generating, for each of a set of pixels in the source image, respective intensity values for multiple colors. The set of pixels may include all of the pixels in the image or a subset of the pixels in the image (e.g., a sub-sample of pixels, a portion or sub-region of the image, etc.). Aspects of the present disclosure recognize that, because each pixel of a source image includes information for a single color, the original source image is significantly smaller than a demosaiced image having the same pixel resolution.

In some aspects, the image analysis component 120 may detect one or more objects in the image 104, and perform various processing operations to identify the detected objects. Referring to FIG. 1B, the image analysis component 120 includes a detection component 132, a normalization component 134, a keypoint component 136, a transformation component 138, an embedding component 140, and a matching component 142. The detection component 132 is configured to receive the image 104 and detect one or more objects of interest (e.g., faces) in the image 104.

While the image capture component 110 may output a demosaiced image for input into a facial recognition process, using the original, non-demosaiced source image as input into a facial recognition process may help reduce memory expense compared to using demosaiced images, as described above. Accordingly, in some aspects, the image 104 shown in FIG. 1A is a source image as captured by the image capture component 110 but yet to be demosaiced into a full-color image.

The detection component 132 is configured to detect one or more object(s) based on an object detection model 162. The object detection model 162 may be trained or otherwise configured to detect objects of interest in images or video. For example, the object detection model 162 may apply one or more transformations to the pixels in the image 104 to create one or more features that can be used for object detection. More specifically, the object detection model 162 may compare the features extracted from the image 104 with a known set of features that uniquely identify a particular class of objects (such as human faces) to determine respective regions of interest (ROIs) indicating a presence or location of any objects of interest in the image 104. In some implementations, the object detection model 162 may be a neural network model. In some other implementations, the object detection model 162 may be a statistical model.

In some implementations, the detection component 132 may output an annotated image 172 that includes one or more bounding box(es) representing ROIs or location(s) of the corresponding object(s) of interest within the image 104. The bounding boxes may be defined by coordinates (e.g., x-y coordinates in a coordinate space of the digital image 104 and/or the image capture component 110) of two or more corners of each ROI.

The normalization component 134 is configured to normalize the annotated image 172 into characteristics (e.g., dimensions) suitable for processing by the keypoint component 136. In some implementations, the keypoint component 136 is configured to accept input images with specific characteristics (e.g., specific dimensions). Accordingly, the normalization component 134 may normalize the annotated image 172 for consistent processing by the keypoint component 136. The normalization component 134 may normalize the annotated image 172 to generate a normalized image 174 for output. In some implementations, normalization operations that may be performed by the normalization component 134 on an image include one or more of rotating the image, resizing (e.g., rescaling), or warping the image.

The keypoint component 136 is configured to receive the normalized image 174 and analyze the ROIs in the normalized image 174 to determine keypoints on detected objects within the ROIs. The keypoints represent “landmarks” on the detected objects that may aid in identification of the objects. For example, keypoints may include various landmarks on a face (e.g., corners of the eyes, the irises of the eyes, endpoints of eyebrows, corners of the mouth, tip of the nose, points on the cheeks, etc.) that may be compared to keypoints associated with known objects (e.g. keypoints associated with known faces).

The keypoint component 136 may analyze a detected object within an ROI in the normalized image 174, extract features from the object (e.g., facial features on a face), and determine keypoints associated with those features based on a keypoint model 164. The keypoint model 164 may be trained or otherwise configured to identify landmarks on objects of interest in images or video and extract those landmarks as features, and to determine keypoints associated with those features. In some implementations, the keypoint model 164 may be a neural network model.

In some implementations, the keypoint component 136 may output a set of keypoints 176 determined for the ROIs in the normalized image 174. Each keypoint 176 may define a set of coordinates (e.g., x-y coordinates in a coordinate space of the digital image 104 and/or the image capture component 110) in the normalized image space.

Some object identification techniques require objects to be oriented in a specific direction for identification. For example, some facial recognition techniques require faces to be oriented in a forward-facing direction for proper identification (e.g., the face is facing straight toward the camera). However, an object of interest 102 may not be looking straight toward at the image capture component 110 at the point of capture. Accordingly, the transformation component 138 may generate a transformation 178 that realigns the keypoints 176 to a forward-facing orientation, in effect realigning the corresponding object of interest to the forward-facing orientation.

As noted above, the transformation component 138 may generate and output a transformation 178. In some implementations, the transformation 178 represents the realigned keypoints. For example, the transformation component 138 may generate the realigned keypoints based on the keypoints 176 and output the realigned keypoints as the transformation 178.

The embedding component 140 is configured to generate an embedding 180 for the normalized image 174. In some aspects, an embedding 180 is a high-dimensional vector that represents the normalized image 174. In particular, the embedding 180 may represent features extracted from the normalized image 174 based on the realigned keypoints of the image (e.g., the transformation 178). In some implementations, the embedding component 140 generates the embedding 180 based on an embedding model 166. The embedding model 166 may be trained or otherwise configured to convert keypoints (e.g., the transformation 178) into a corresponding embedding. In some implementations, the embedding model 166 may be a neural network model.

The matching component 142 compares the embedding 180 to embedding templates 150 in order to identify an embedding template, if any, that most closely matches the embedding 180. As used herein, an embedding template is an embedding corresponding to a known face (e.g., in a dataset of known faces associated with a database of known persons). The embedding templates 150 may be generated from keypoints associated with those known persons. For example, an embedding template for a person may be generated from keypoints determined for the face of that person and added to a dataset, which may in turn be stored in or otherwise linked to a database (e.g., a database of known persons). In some implementations, the embedding templates 150 are generated based on forward-facing orientation of the faces. A dataset of known faces may have an embedding template 150 for each person in a database of known persons, and an entry for a person in the database of known persons may include an embedding template identifier referencing or pointing to the embedding template corresponding to that person in the dataset.

In some implementations, the matching component 142 computes a respective Euclidian distance or a cosine similarity between the embedding 180 and each embedding template 150 in a dataset of embedding templates. Based on the computations, the matching component 142 selects an embedding template 150 that is closest (based on the Euclidian distance or cosine similarity) to the embedding 180. In some implementations, the matching component 142 may also compare a computed Euclidian distance or cosine similarity to a predetermined threshold. That is, the Euclidian distance or cosine similarity must exceed a minimum threshold in order for the corresponding embedding template 150 to be eligible for selection.

Upon selecting a closest embedding template 150 (whose Euclidian distance or cosine similarity to the embedding 180 exceeds the threshold), the matching component 142 may output an inference 106. In some implementations, the inference 106 may include an identifier of the selected embedding template 150. If the matching component 142 fails to select an embedding template (e.g., none of the embedding templates 150 has a Euclidian distance or cosine similarity to the embedding 180 that exceeds the threshold), the matching component 142 may output a null value as the inference 106.

The image analysis component 120 may output the inference 106. For example, referencing back to FIG. 1A, the inference 106 is depicted as an identifier “Face ID: User A” identifying the person corresponding to the selected embedding template 150 that is closest to the embedding 180. As described above, if the matching component 142 fails to select an embedding template 150, the inference 106 may be a null value or other indication that the object of interest is unidentifiable by the image analysis component 120.

In some implementations, the image analysis system 100 includes a limited memory allocation (also referred to as a “memory space”) for use by the image analysis component 120. The memory space may include all or a portion of physical and/or virtual memory in a device or system in which the image analysis system 100 is implemented. The memory space may be reserved or otherwise made available for operations to be performed by the image analysis system 100 (e.g., by the image analysis component 120). In some implementations, the memory space may be further partitioned or subdivided for operation in conjunction with the object detection model 162, keypoints model 164, and an embedding model 166. The memory space also may include a portion reserved as an input buffer for buffering an input image.

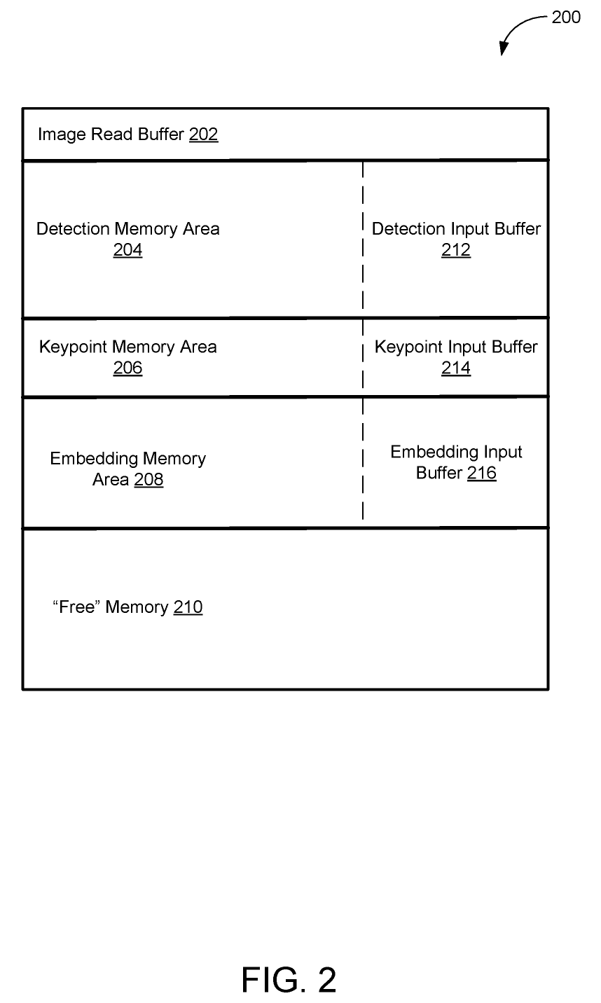

FIG. 2 shows an example memory space 200 for an image analysis system 100, according to some implementations. As indicated above, a memory space within a device or a system may be reserved for operations of the image analysis component 120. The memory space 200 may include respective portions (e.g., “memory areas”) allocated to specific operations or components of the image analysis component 120, and space for buffering respective inputs into the image analysis component 120 and/or inputs into respective components within the image analysis component 120. The memory space 200 may also include “free” space that may be allocated or otherwise used by any operation or component of the image analysis component 120 as needed.

As shown, memory space 200 includes an image read buffer 202, a detection memory area 204, a keypoint memory area 206, an embedding memory area 208, and “free” memory 210. The image read buffer 202 is configured to store an image received from the input capture component 110. In some implementations, the image analysis component 120 reads the input image 104 from the image capture component 110 and stores the read image into the image read buffer 202. In some implementations, the size of the image read buffer 202 is configured or set for storing a source image to be used as an input image (e.g., image 104) into the image analysis component (e.g., image analysis component 110). For example, if source images for input into the image analysis component are HD resolution, then the size of the image read buffer 202 is predetermined to fit an HD-resolution source image.

The detection memory area 204 is configured to be used by the detection component 132. The detection memory area 204 may be used as working memory for the detection model 162. The detection memory area 204 includes a detection input buffer 212 for storing data to be input the detection model 162. In some implementations, the memory space of the detection input buffer 212 may also be used as working memory for the detection model 162 during computation of the detection model 162 (e.g., when the input data stored in the detection input buffer 212 is no longer needed). In some implementations, the detection input buffer 212 has the same size as the image read buffer 202. That is, the size of the detection input buffer 212 may be configured or set to fit the input image stored in the image read buffer 202.

The keypoint memory area 206 is configured to be used by the keypoint component 136. The keypoint memory area 206 may be used as working memory for the keypoint model 164. The keypoint memory area 206 includes a keypoint input buffer 214 for storing data to be input into the keypoint model 164. In some implementations, the memory space of the keypoint input buffer 214 may also be used as working memory for the keypoint model 164 during computation of the keypoint model 164 (e.g., when the input data stored in the keypoint input buffer 214 is no longer needed).

The embedding memory area 208 is configured to be used by the embedding component 138. The embedding memory area 208 may be used as working memory for the embedding model 166. The embedding memory area 208 includes an embedding input buffer 216 for storing data to be input into the embedding model 166. In some implementations, the memory space of the embedding input buffer 216 may also be used as working memory for the embedding model 166 during computation of the embedding model 166 (e.g., when the input data stored in the embedding input buffer 216 is no longer needed).

The “free” memory 210 is configured to be available to be used by any of the components of the image analysis component 120 as needed. That is, the “free” memory 210 may be used as working memory, temporary storage, or the like by any of the components of the image analysis component 120. For example, the embedding component 138 may store its output (e.g., embedding 180) in the “free” memory 210. The matching component 142 may read the embedding 180 in the “free” memory 210 and use the “free” memory 210 to buffer embedding templates 150 that may be compared to the embedding 180.

Referring back to FIG. 1A, in some aspects, the image capture component 110 captures image 104 at a high definition (“HD”) or a higher resolution. As used herein, HD resolution refers to an image resolution of 720 x 1280 pixels (or 1280 x 720, depending on whether the image is in portrait or landscape orientation). Aspects of the present disclosure recognize that while an image in HD resolution may provide more input information for the operations of the image analysis component 120 (e.g., more and/or clearer detail), a demosaiced, full-color HD image also occupies more memory than a demosaiced, full-color image of a lower resolution (e.g., a VGA resolution (640 x 480) image). In some aspects, the data size of a demosaiced, full-color HD image may exceed the memory space 200 reserved for the image analysis component 120. As indicated above, aspects of the present disclosure recognize that a source image form occupies less memory than the demosaiced, full-color form of that image, including when the image is in HD resolution. Aspects of the present disclosure also recognize that some operations associated with the image analysis component 120 may be more efficiently performed on demosaiced images as opposed to non-demosaiced images. Accordingly, while the image analysis component 120 may receive a source image as the input image 104, eventual demosaicing of image data within the image analysis component 120 may still be desirable. Aspects of the present disclosure thus recognize that, in order to remain within a memory budget associated with the memory space 200, an image analysis component may, during a facial recognition process for a given input image, demosaic a portion of the input image up to certain dimensions, and further may reuse (e.g., write over) certain portions of the memory space 200.

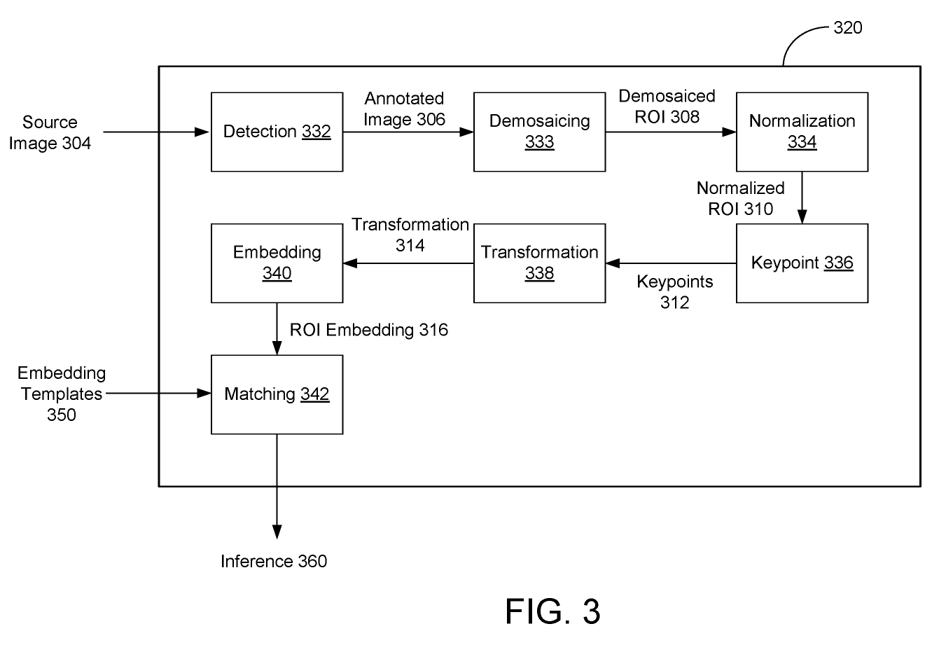

FIG. 3 shows a block diagram of an example image analysis component 320, according to some implementations. The image analysis component 320 may detect one or more objects in an image, and perform various processing operations on the image, in order to identify the detected objects. The image analysis component 320 is configured to use a memory space 200 for its operations. In some implementations, the image analysis component 320 is an example of the image analysis component 120.

As shown, the image analysis component 320 includes a detection component 332, a demosaicing component 333, a normalization component 334, a keypoint component 336, a transformation component 338, an embedding component 340, and a matching component 342. In some implementations, the detection component 332, normalization component 334, keypoint component 336, transformation component 338, embedding component 340, and matching component 342 are examples of the detection component 132, normalization component 134, keypoint component 136, transformation component 138, embedding component 140, and matching component 142, respectively.

In some aspects, the image analysis component 320 may detect one or more objects in a source image 304, and perform various processing operations, in order to identify the detected objects. The image analysis component 320 (e.g., the detection component 332) is configured to receive a source image 304 (e.g., the image 104) from an image capture component (e.g., the image capture component 110). In some implementations, the image analysis component 320 (e.g., the detection component 332) reads the source image 304 from the image capture component and stores the source image 304 in the image read buffer 202. The image analysis component 320 copies the source image 304, stored in the image read buffer 202, into the detection input buffer 212 of the detection memory area 204. Thus, at this point there are two copies of the source image 304 stored in the memory space 200, one in the image read buffer 202 and another in the detection input buffer 212 of the detection memory area 204.

The detection component 332 is configured to detect one or more objects of interest (e.g., faces) in the copy of the source image 304 stored in the detection input buffer 212. The detection component 332 may detect the object(s) based on an object detection model (e.g., object detection model 162). For example, the object detection model 162 may apply one or more transformations to the pixels in the copy of the source image 304 in the detection input buffer 212 to create one or more features that can be used for object detection. More specifically, the object detection model 162 may compare the features extracted from the copy of the source image 304 in the detection input buffer 212 with a known set of features that uniquely identify a particular class of objects (such as human faces) to determine respective ROIs indicating a presence or location of any objects of interest in the source image 304. In some implementations, the detection component 332 may use the detection memory area 204 as working memory for detecting the objects (e.g., for storing weights associated with the object detection model 162).

In some implementations, the detection component 332 may output an annotated image 306 that includes one or more bounding box(es) representing ROIs or location(s) of the corresponding object(s) of interest within the source image 304. In some implementations, the detection component 332 may output the annotated image 306 or just the annotations indicating the ROIs (e.g., coordinates of the ROI bounding boxes) to the free memory 210 and store the annotated image 306 there, separately from the source image 304 in the image read buffer 202 or the detection input buffer 212. Coordinates for a ROI bounding box may include coordinates (e.g., x-y coordinates in a coordinate space of the source image 304 and/or the image capture component) of two or more corners defining the ROI bounding box.

The demosaicing component 333 is configured to demosaic a portion of the source image 304, in particular a portion of the source image 304 corresponding to an ROI. In some implementations, demosaicing component 333 may obtain the coordinates defining the ROI from the annotated image 306. Based on the obtained ROI coordinates, the demosaicing component 333 reads the portion of the source image 304 corresponding to the ROI from the source image 304 stored in the image read buffer 202. In some other implementations, the demosaicing component 333 reads the source image 304 stored in the image read buffer 202 and crops the read source image 304 to the portion corresponding to the ROI. In either case, the source image 304 stored in the image read buffer 202 is unmodified. The demosaicing component 333 demosaics the read or cropped ROI portion of the source image 304 into a demosaiced ROI 308. The demosaicing component 333 outputs the demosaiced ROI 308 into the detection input buffer 212 of the detection memory area 204. Thus, the demosaiced ROI 308 is a demosaiced, full-color image that is smaller in dimensions than the source image 304 and corresponding to an ROI in the source image 304.

In some implementations, when the detection component 332 has detected the objects of interest in the copy of the source image 304 in the detection input buffer 212, that copy of the source image 304 is no longer needed. Accordingly, the detection input buffer 212 may be re-used to store the demosaiced ROI 308, as described above. That is, the demosaiced ROI 308 overwrites whatever data is stored in the detection input buffer 212 (e.g., the copy of the source image 304).

In some implementations, assuming that the source image 304 is an HD image, the demosaicing component 333 demosaics an ROI, up to a resolution that is smaller than HD resolution (e.g., up to VGA resolution of 640 x 480). For example, if the ROI is smaller than or equal to VGA resolution, the demosaicing component 333 may demosaic the entire ROI. In some implementations, if the ROI is larger than VGA resolution, then the demosaicing component 333 may demosaic a VGA-resolution sub-region of the ROI (e.g., a sub-region centered on the center of the ROI). In some implementations, the data size of the demosaiced ROI fits within the size of the detection input buffer 212. For example, the data size of an HD-resolution source image is approximately the same as the data size of a VGA-resolution full-color image. Accordingly, the demosaicing component 333 may demosaic an ROI up to VGA resolution, so that the resulting demosaiced ROI may be stored in the detection input buffer 212. For source image inputs of different resolutions and memory spaces of different sizes (e.g., how much memory in the memory space is available for the detection input buffer 212), the maximum resolution for the demosaiced ROI may be different.

In some implementations, if the ROI is larger than VGA resolution, then the demosaicing component 333 may demosaic a sub-sample of the pixels in the ROI (which may be referred to as a “coarse” demosaicing, versus a “fine” demosaicing in which all of the pixels in the ROI or a sub-region thereof are demosaiced), with the demosaiced result having the same larger-than-VGA resolution as the ROI but whose data size still fits within the detection input buffer 212. By demosaicing a larger-than-VGA ROI coarsely, the resulting demosaiced ROI may occupy a similar or even smaller amount of memory than a finely demosaiced ROI of VGA resolution. As indicated above, in some implementations, the data size of the demosaiced ROI fits within the size of the detection input buffer 212. Accordingly, the number of pixels sub-sampled in a coarse demosaic operation may differ based on the resolution of the source image input and the size of the memory space (e.g., how much memory in the memory space is available for the detection input buffer 212).

The normalization component 334 is configured to normalize the demosaiced ROI 308 into characteristics (e.g., dimensions) suitable for processing by the keypoint component 336. The normalization component 334 may read the demosaiced ROI 308 from the detection input buffer 212, normalize (e.g., rotate, resize, warp) the demosaiced ROI 308 into a normalized ROI 310, and output the normalized ROI 310 into the keypoint input buffer 214 of the keypoint memory area 206.

The keypoint component 336 is configured to read the normalized ROI 310 from the keypoint input buffer 214 and analyze the normalized ROI 310 to determine keypoints on detected objects within the normalized ROI 310. The keypoint component 336 may analyze a detected object within the normalized ROI 310, extract features from the object (e.g., facial features on a face), and determine keypoints associated with those features based on a keypoint model (e.g., keypoint model 164). In some implementations, the keypoint component 336 may use the keypoint memory area 206 as working memory for determining the keypoints (e.g., for storing weights associated with the keypoint model 164).

In some implementations, the keypoint component 336 may output a set of keypoints 312 determined for the normalized ROI 310. Each keypoint 312 may may define a set of coordinates (e.g., x-y coordinates in a coordinate space of the source image 304 and/or the image capture component 110) in the normalized ROI 310. In some implementations, the keypoint component 336 may output the keypoints 312 to the free memory 210.

The transformation component 338 is configured to receive the keypoints 312 (e.g., read the keypoints 312 from the free memory 210) and generate a transformation 314 that realigns the keypoints 312 to a forward-facing orientation, in effect realigning the corresponding object of interest to the forward-facing orientation. In some implementations, the transformation 314 represents the realigned keypoints. The transformation component 338 outputs the transformation 314 into the embedding input buffer 216 of the embedding memory area 208.

The embedding component 340 is configured to generate an ROI embedding 316 for the normalized ROI 310. In some aspects, an ROI embedding 316 is a high-dimensional vector array that represents the normalized ROI 310. In particular, the ROI embedding 316 may represent features extracted from the normalized ROI 310 based on the realigned keypoints of the image (e.g., the transformation 314). In some implementations, the embedding component 340 generates the ROI embedding 316 based on an embedding model (e.g., embedding model 166).

In some implementations, the embedding component 340 is configured to read the transformation 314 from the embedding input buffer 216 of the embedding memory area 208 and apply the embedding model 166 to the transformation 314. The embedding component 340 may output the embedding 316 and store the embedding 316 in the free memory 210.

The matching component 342 compares the ROI embedding 316 to embedding templates 350 in order to identify an embedding template, if any, that most closely matches the ROI embedding 316. In some implementations, the embedding templates 350 are an example of the embedding templates 150.

In some implementations, the matching component 342 computes a respective Euclidian distance or a cosine similarity between the ROI embedding 316 and each embedding template 350 in a dataset of embedding templates. Based on the computations, the matching component 342 selects an embedding template 350 that is closest (based on the Euclidian distance or cosine similarity) to the ROI embedding 316. In some implementations, the matching component 342 may also compare a computed Euclidian distance or cosine similarity to a predetermined threshold. That is, the Euclidian distance or cosine similarity must exceed a minimum threshold in order for the corresponding embedding template 350 to be eligible for selection.

Upon selecting a closest embedding template 350 (whose Euclidian distance or cosine similarity to the ROI embedding 316 exceeds the threshold), the matching component 342 may output an inference 360. In some implementations, the inference 360 may be an example of the inference 106. In some implementations, the inference 360 may include an identifier of that selected embedding template 350 or an indication that the object of interest in the ROI is not identifiable by the image analysis component 320 (e.g., a null value).

In some implementations, the detection component 332 may detect multiple objects of interest in the source image 304 and determine an ROI for each detected object. In such a case, the image analysis component 320 may process each ROI one at a time. For example, the components 333, 334, 336, 338, 430, and 342 may perform the operations described above for a first ROI and output a first inference 360 for the first ROI. Then, the image analysis component 320 may select a second, yet to be processed ROI from the multiple ROIs, repeat the above-described operations for the second ROI, and output a second inference for the second ROI. Thus, the image analysis component 320 may iterate the process described above with respect to components 333 thru 342 for each ROI indicated in the annotated image 306.

In an example implementation, the image analysis component 320 and the memory space 200 are implemented on a device that has memory of approximately 2450 kilobytes (“KiB”) allocated to the image analysis component 320. That is, in this example implementation, the total size of the memory space 200, and thus a memory budget for the image analysis component 320, is approximately 2450 KiB. Within the memory space 200 in this example implementation, and assuming that the input image (e.g. image 304) into the image analysis component 320 is an HD-resolution source image, approximately 900 KiB (i.e., sufficient space to store an HD-resolution source image, which is about 720 * 1280 * 1 ≈ approximately 922 KiB) may be allocated to be used as the image read buffer 202 for storing the source image 304. Approximately 1227.5 KiB of the memory space 200 may be allocated to be used as the detection memory area 204, of which approximately 900 KiB may be used as a detection input buffer 212 (i.e., sufficient space to store a copy of the source image 304). Approximately 23.6 KiB of the memory space 200 may be allocated to be used as the keypoint memory area 206, and a portion of that keypoint memory area 206 may be used as a keypoint input buffer 214. Approximately 115.5 KiB of the memory space 200 may be allocated to be used as the embedding memory area 208, and a portion of that embedding memory area 208 may be used as an embedding input buffer 216. The remaining memory in the memory space 200 (approximately 100 KiB) may be allocated as free memory 210. If the input image into the image analysis component 320 is instead a demosaiced, full-color HD image, this example implementation would not be possible because the size of the full-color HD image would occupy more memory (720 * 1280 * 3 ≈ approximately 2765 KiB) than the size of the memory space 200.

It should be appreciated that while the techniques described above are described with reference to HD and VGA resolutions, the above-described techniques are applicable to source images and demosaiced ROIs of different resolutions (e.g., source images of even higher resolutions than HD, demosaiced ROIs that may be larger or smaller than VGA resolution). For example, the source image 304 may have an even higher resolution (e.g., 1600 x 900, 1920 x 1080). The size of the memory space 200 and the spaces allocated therein may be sized accordingly for the larger source image. Further, the resolution and/or the data size of the demosaiced ROI may also be sized accordingly based on the size of the source image and the memory budget associated with the memory space 200 (e.g., how much memory in the memory space is available for the detection input buffer 212). Further, it should be appreciated that the above techniques are applicable to other computer vision technologies besides facial recognition.

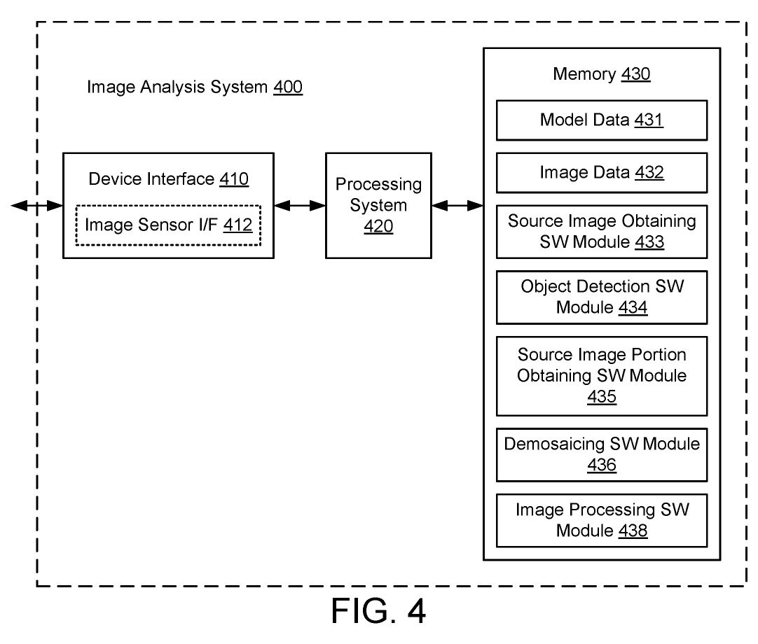

FIG. 4 shows another block diagram of an example image analysis system 400, according to some implementations. More specifically, the image analysis system 400 may be configured to detect one or more objects of interest in a source image. Further, the image analysis system 400 may be configured to obtain a portion of the source image, demosaic the portion of the source image, and process the demosaiced portion of the source image. In some implementations, the image analysis system 400 may be one example of the image analysis system 100 of FIG. 1 and the image analysis component 320 of FIG. 3. The image analysis system 400 includes a device interface 410, a processing system 420, and a memory 430.

The device interface 410 is configured to communicate with one or more components of an image capture device (such as the image capture component 110 of FIG. 1). In some implementations, the device interface 710 may include an image sensor interface (I/F) 412 configured to receive a source image via an image capture device.

The memory 430 may include a data store 431 configured to store one or more models for object detection, keypoint generation, and embedding generation, and a data store 432 configured to store one or more source images and cropped and demosaiced source images. The memory 430 also may include a non-transitory computer-readable medium (including one or more nonvolatile memory elements, such as EPROM, EEPROM, Flash memory, or a hard drive, among other examples) that may store at least the following software (SW) modules: a source image obtaining SW module 433 to obtain a source image; an object detection SW module 434 to detect one or more objects of interest in the source image; a source image portion obtaining SW module 435 to obtain a portion of the source image based on the one or more detected objects of interest and a buffer size associated with detecting the one or more objects of interest in the source image; a demosaicing SW module 436 to demosaic the portion of the source image; and a image processing SW module 438 to perform one more image processing operations based on the demosaiced portion of the source image.

Each software module includes instructions that, when executed by the processing system 420, causes the image analysis system 400 to perform the corresponding functions.

The processing system 420 may include any suitable one or more processors capable of executing scripts or instructions of one or more software programs stored in the image analysis system 400 (such as in the memory 430). For example, the processing system 420 may execute the object detection SW module 433 to detect one or more objects of interest in a source image, and may execute the source image portion obtaining SW module 434 to obtain a portion of the source image based on the one or more detected objects of interest and a buffer size associated with detecting the one or more objects of interest in the source image.

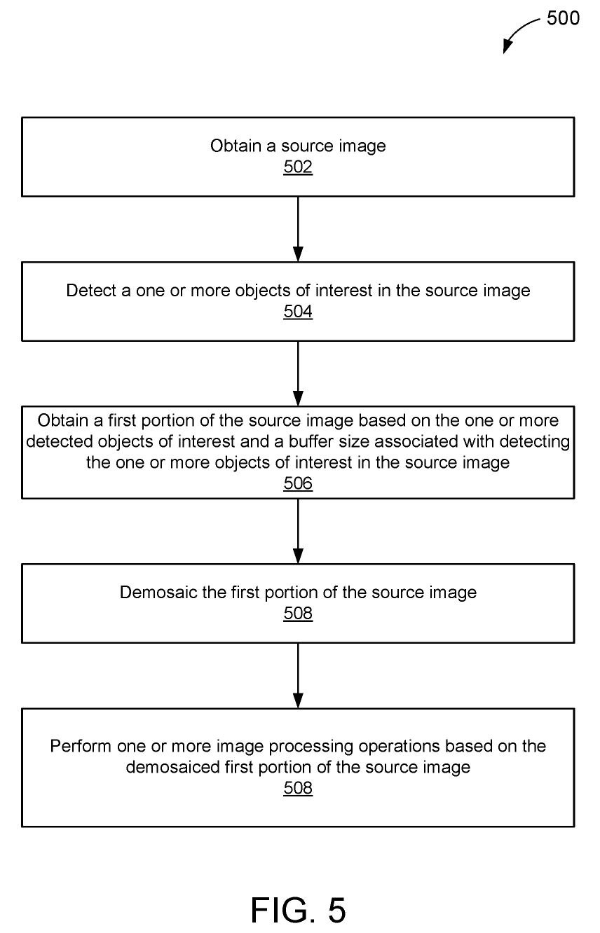

FIG. 5 shows an illustrative flowchart depicting an example operation 500 for object detection, according to some implementations. In some implementations, the example operation 500 may be performed by an image analysis system, such as the image analysis component 320 of FIG. 3.

The image analysis system may obtain a source image (502). The image analysis system may detect one or more objects of interest in the source image (504). The image analysis system may obtain a first portion of the source image based on the one or more detected objects of interest and a buffer size associated with detecting the one or more objects of interest in the source image (506). The image analysis system may demosaic the first portion of the source image (508). The image analysis system may perform one or more image processing operations based on the demosaiced first portion of the source image (510).

In some aspects, the image analysis system may select a first region of interest (ROI) in the source image based on a first detected object of interest, wherein the first portion of the source image includes only the selected first ROI.

In some aspects, the image analysis system may obtain a second portion of the source image based on a second ROI in the source image and the buffer size associated with detecting the one or more objects of interest in the source image; demosaic the second portion of the source image; and perform the one or more image processing operations on the demosaiced second portion of the source image.

In some aspects, the image analysis system may store the source image in a first memory region of a predetermined memory space; store a copy of the source image in a second memory region of the predetermined memory space, wherein a size of the second memory region is the buffer size; and detect the one or more objects of interest in the copy of the source image stored in the second memory region.

In some aspects, the image analysis system may store the demosaiced first portion of the source image in the second memory region.

In some aspects, the image analysis system may normalize the demosaiced first portion of the source image.

In some aspects, the image analysis system may rotate, resize, or warp the demosaiced first portion of the source image.

In some aspects, the image analysis system may store the normalized first portion of the image in a third memory region of the predetermined memory space.

In some aspects, the image analysis system may determine a plurality of keypoints associated with the demosaiced first portion of the source image.

In some aspects, the image analysis system may generate a transformation of the plurality of keypoints; generate an image embedding based on the transformation; and select an embedding template from a plurality of embedding templates based on the generated image embedding.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method, comprising:
obtaining a source image;
detecting one or more objects of interest in the source image;
obtaining a first portion of the source image based on the one or more detected objects of interest and a buffer size associated with detecting the one or more objects of interest in the source image;
demosaicing the first portion of the source image; and
performing one or more image processing operations based on the demosaiced first portion of the source image.

2. The method of claim 1, wherein the obtaining of the first portion of the source image comprises:
selecting a first region of interest (ROI) in the source image based on a first detected object of interest, wherein the first portion of the source image includes only the selected first ROI.

3. The method of claim 2, further comprising:
obtaining a second portion of the source image based on a second ROI in the source image and the buffer size associated with detecting the one or more objects of interest in the source image;
demosaicing the second portion of the source image; and
performing the one or more image processing operations on the demosaiced second portion of the source image.

4. The method of claim 1, further comprising:
storing the source image in a first memory region of a predetermined memory space; and
storing a copy of the source image in a second memory region of the predetermined memory space, wherein a size of the second memory region is the buffer size;
wherein the detecting of the one or more objects of interest in the source image comprises detecting the one or more objects of interest in the copy of the source image stored in the second memory region.

5. The method of claim 4, wherein the demosaicing of the first portion of the source image comprises storing the demosaiced first portion of the source image in the second memory region.

6. The method of claim 4, wherein the performing of the one or more image processing operations based on the demosaiced first portion of the source image comprises normalizing the demosaiced first portion of the source image.

7. The method of claim 6, wherein normalizing the demosaiced first portion of the source image comprises one or more of rotating, resizing, or warping the demosaiced first portion of the source image.

8. The method of claim 6, further comprising storing the normalized first portion of the source image in a third memory region of the predetermined memory space.

9. The method of claim 1, wherein the performing of the one or more image processing operations on the demosaiced first portion of the source image comprises determining a plurality of keypoints associated with the demosaiced first portion of the source image.

10. The method of claim 9, wherein the performing of the one or more image processing operations on the demosaiced first portion of the source image further comprises:
generating a transformation of the plurality of keypoints;
generating an image embedding based on the transformation; and
selecting an embedding template from a plurality of embedding templates based on the generated image embedding.

11. An image analysis system, comprising:
one or more processors; and
a memory coupled to the one or more processors, the memory storing instructions that, when executed by the one or more processors, cause the image analysis system to:
obtain a source image;
detect one or more objects of interest in the source image;
obtain a first portion of the source image based on the one or more detected objects of interest and a buffer size associated with detecting the one or more objects of interest in the source image;
demosaic the first portion of the source image; and
perform the one or more image processing operations based on the demosaiced first portion of the source image.

12. The image analysis system of claim 11, wherein the memory stores instructions that, when executed by the one or more processors, cause the image analysis system to:
select a first region of interest (ROI) in the source image based on a first detected object of interest, wherein first portion of the source image includes only the selected first ROI.

13. The image analysis system of claim 12, wherein the memory stores instructions that, when executed by the one or more processors, cause the image analysis system to:
obtain a second portion of the source image based on a second ROI in the source image and the buffer size associated with detecting the one or more objects of interest in the source image;
demosaic the second portion of the source image; and
perform the one or more image processing operations on the demosaiced second portion of the source image.

14. The image analysis system of claim 11, wherein the memory comprises a predetermined memory space, and wherein the memory stores instructions that, when executed by the one or more processors, cause the image analysis system to:
store the source image in a first memory region of the predetermined memory space;
store a copy of the source image in a second memory region of the predetermined memory space, wherein a size of the second memory region is the buffer size; and
detect the one or more objects of interest in the copy of the source image stored in the second memory region.

15. The image analysis system of claim 14, wherein the memory stores instructions that, when executed by the one or more processors, cause the image analysis system to: store the demosaiced first portion of the source image in the second memory region.

16. The image analysis system of claim 14, wherein the memory stores instructions that, when executed by the one or more processors, cause the image analysis system to: normalize the demosaiced first portion of the source image.

17. The image analysis system of claim 16, wherein the memory stores instructions that, when executed by the one or more processors, cause the image analysis system to: one or more of rotate, resize, or warp the demosaiced first portion of the source image.

18. The image analysis system of claim 16, wherein the memory stores instructions that, when executed by the one or more processors, cause the image analysis system to: store the normalized first portion of the image in a third memory region of the predetermined memory space.

19. The image analysis system of claim 11, wherein the memory stores instructions that, when executed by the one or more processors, cause the image analysis system to: determine a plurality of keypoints associated with the demosaiced first portion of the source image.

20. The image analysis system of claim 19, wherein the memory stores instructions that, when executed by the one or more processors, cause the image analysis system to:
generate a transformation of the plurality of keypoints;
generate an image embedding based on the transformation; and
select an embedding template from a plurality of embedding templates based on the generated image embedding.
